(19) United States
(12) Patent Application Publication
(10) Pub. No.: US 2008/0196292 A1
(43) Pub. Date: Aug. 21, 2008

(54) Tremor

(76) Inventor: Paul Alexander Bruell, Dudley, MA (US)

Correspondence Address: PAUL A. BRUELL, 6 PATTISON AVE., P.O. BOX 1515, DUDLEY, MA, 01571, US

(21) Appl. No.: 11/675,634

(22) Filed: Feb. 16, 2007

(51) Int. Cl. A01K 91/06

(52) U.S. Cl. 43/19.2

(57) ABSTRACT

An elongated device with a self-contained vibration generating mechanism including a battery driven motor and eccentric weight and means to vary the vibration that can be easily attached to an ordinary fishing rod having a reel and line mounted thereon to cause the fishing rod shaft to vibrate in a manner to cause a bait or lure attached to the line to vibrate in a selective manner to attract fish, without passing the fishing line through the device. The device is firmly detachably attached to a fishing rod shaft by the combination of an extension of the device having a curvilinear cavity defined by a wall adapted to frictionally engage the top of a fishing rod shaft co-acting with a pair of straps wrappable around the device and secured by a hook and loop fastening system

### BACKGROUND OF INVENTION

The present invention relates to a detachable device for converting an ordinary fishing rod into one which has a controllable vibration for causing a lure attached to the line of the fishing rod to tremble.

It is known that if a fishing rod can be made to vibrate it will cause a lure attached to the end of the line to move in a fluttering action that attracts fish to strike. Some prior art devices attempted to achieve this by manufacturing a rod that contains a vibrator as an integral part of the device, such as, for example, U.S. Pat. Nos. 6,785,998 and 6,836,995. This had the disadvantage that the user had to buy the particular rod. Not only is such rod costly, but it limits the user to that particular rod. Fishermen are very particular about rods and the action that the rods play in casting a lure and playing and landing a fish, and want to have the freedom to select from a variety of rods of different lengths, materials and action.

Other prior art devices such as U.S. Pat. Nos. 4,700,501 and 3,789,534 have detachable vibration devices which are cumbersome to attach, and have the line passing through the vibrating device and then through the eyelets of the rod. The feeding of the line modifies the particular inter-action of the rod reel and line intended by the manufacturer for the fishing line to pass from the reel through the eyelets to achieve a certain co-action between the rod and line which was intended by the manufacturer of the rod and tension on the line intended by the manufacturer of the reel to affect the action of the rod and the line in casting the line and in hooking and reeling in a fighting fish.

Other prior art devices such as U.S. Pat. No. 6,920,774 required the power supply and switching and electrical adjustments to be placed separate from the fishing rod and connected by wires. This is not only cumbersome but it can also interfere with the freedom to hold the rod at any angle when casting and can cause the wire to become entangled with other items in the boat or on the dock.

Still other devices had means for attaching a vibrating mechanism to a rod in a manner where the attachment means were cumbersome and difficult to attach and detach. This is a problem not only in the initial installation, but when a fisherman want to use a vibration apparatus for only part of their fishing day, and to try some fishing without it, much as they change lures when the fish are not biting to the degree that the fisherman desires.

Moreover, some fishermen have more than one rod, and want to change the rod either to go after different kinds of fish, or because they want to try different kinds of rod actions

Each of the different rods may have different cross-sectional dimensions of the shaft, complicating or prohibiting the attachment of a vibrating device on range of different fishing rods.

Still others were subject to loosening and slipping on the device thereby severely interfering with the action of the rod in hooking, playing and landing a fish, or even causing the device to fall from the rod. This tendency to slip is compounded not only because of the forces attempting to loosen the attachment of the vibrating device that come from the action of the rod in casting and reeling in a fish, but also from the very vibrations generated by the device. Thus, it is essential that the means to fasten the device create a strong attachment.

Accordingly there is a need for a fisherman to have a vibrating device that can be attached and unattached either to the same, or more than one, fishing rod easily and quickly, yet having the same firm attachment each that does not become loosened during the casting, hooking, playing and landing of a fish.

### SUMMARY OF THE INVENTION

A selective vibration generating device readily attachable to and detachable from a conventional fishing rod by an attachment means that not only is easy to attach and detach, but that firmly secures the device from shifting axially of, or rotating on, the shaft, and permits the transmission of selective vibrations to the fishing rod shaft and then to the fishing line that passes from a conventional reel through the conventional eyelets of the fishing rod without passing through the device to cause the fishing line, and any bait or lure attached thereto, to selectively vibrate. The attachment is secured from moving axially or circumferentially of the fishing rod shaft by combination of a rubber or silicone extension having a concave downward facing cavity to establish frictional engagement of the upper surface of the fishing rod shaft, and hook and loop fastening straps that co-act with the extension to effectively secure the device against movement of the device axially of, or rotationally on, the fishing rod shaft when the attachment secures the device to a range of fishing rod shaft diameters, and is subjected to the extreme forces involved in casting a lure or bait and in hooking playing and landing of a fish. In a modification, the extension is of a resilient material to self-adjustingly facilitate the assembly of the device on fishing rod shafts of a range of diameters.

### BRIEF DESCRIPTION OF THE DRAWINGS

A preferred embodiment of the present invention is described in detail below with reference to the attached drawing figures, wherein:

FIG. 1 is a side view of the device assembled on the shaft of a conventional fishing rod that has a conventional reel that feeds a conventional line through the conventional loops of the shaft of the rod, with a lure mounted at the end of the line;

FIG. 2 is a cross-sectional side view of the device prior to assembly on the fishing rod taken along the lines 2-2 in FIG. 4;

FIG. 3 is an elevation view of the device prior to assembly on the fishing rod.

FIG. 4 is a back view of the device prior to assembly on the fishing rod and showing the extension and the straps having hook and loop mating surfaces;

FIG. 5 is a partial cross sectional end view of the device mounted on a fishing rod shaft where the cavity defined by the wall at the bottom of the extension is deep

FIG. 6 is a cross sectional end view of a modification of the device mounted on a fishing rod shaft where the extension is sufficiently resilient to cause the extension cavity wall to expand on application of the extension to the fishing rod shaft;

FIG. 7 is a cross sectional end view of the device mounted on a fishing rod shaft where the cavity defined by the wall at the bottom of the extension is shallower than the cavity of FIG. 5 and the fishing rod shaft is of greater diameter than the fishing rod shaft of FIG. 5;

FIG. 8 is a cross sectional end view of the device mounted on a fishing rod shaft with the extension and a strap in assembled position on a fishing rod shaft.

FIG. 9 is a cross sectional end view of the device mounted on a fishing rod shaft where the depth of the cavity is the same as the depth of the cavity of the extension of FIG. 7, and the diameter of the fishing rod is the same as on FIG. 6.

### DETAILED DESCRIPTION

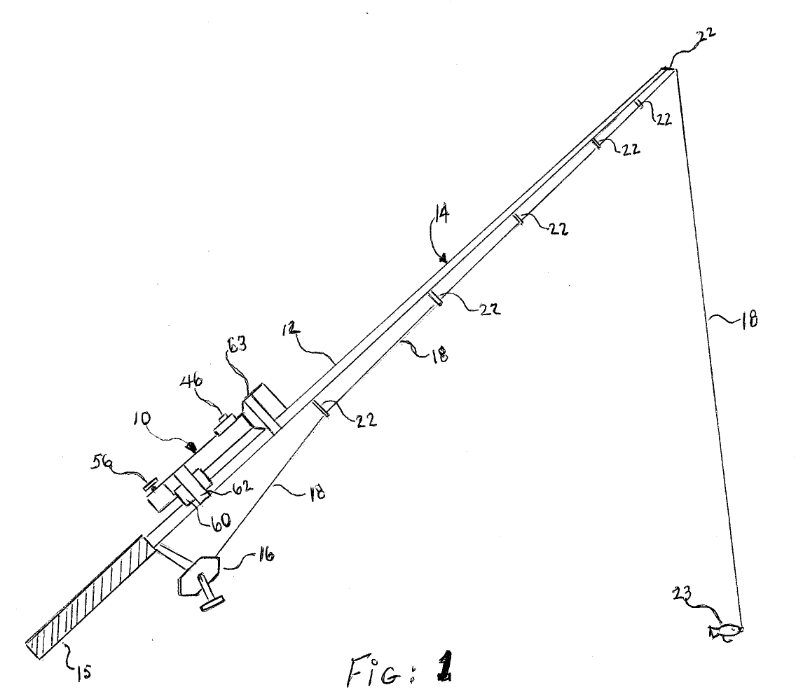

FIG. 1, shows an assembled view of a device 10 in accordance with the preferred embodiment of the present invention mounted above the shaft 12 of a conventional fishing rod 14 adjacent its handle 15. A conventional reel 16 is mounted above the handle. A fishing line 18 passes directly from the reel 16 through the conventional eyelets 22 of the shaft 12 and has a lure 23 attached at its end.

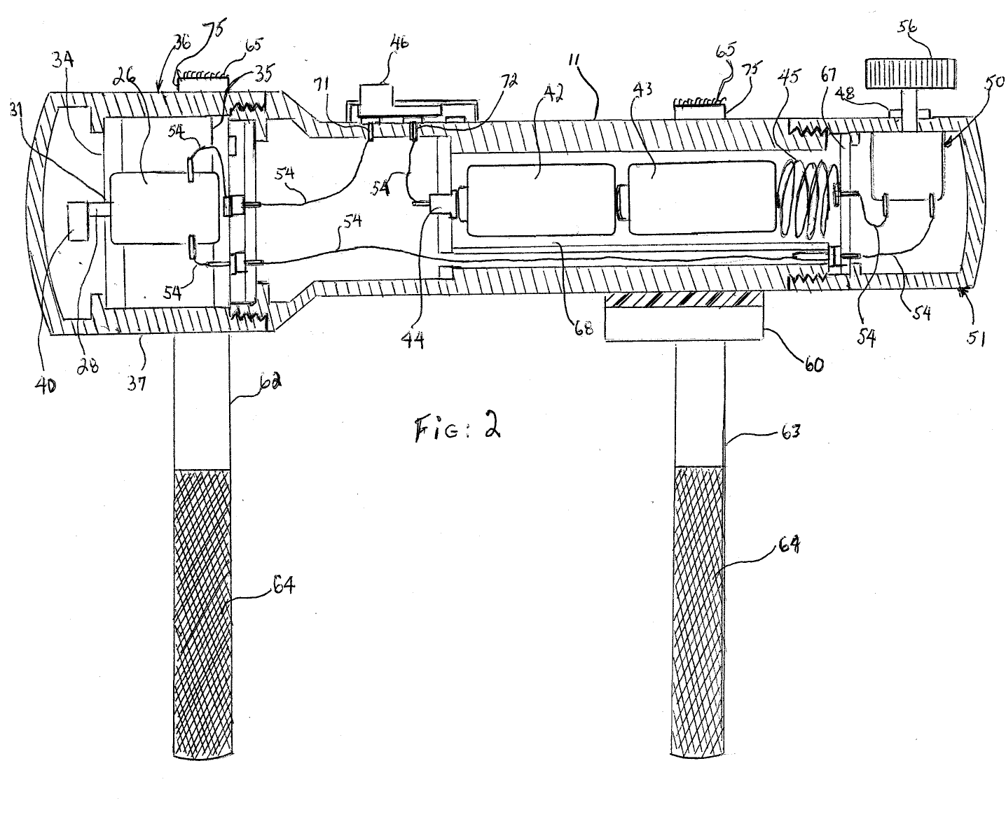

FIG. 2 shows a partially cross sectional and partially broken away side elevation view of the device 10 prior to its attachment to the shaft 12 of the conventional fishing rod 14. The device 10 has an elongated hollow cylindrical casing 11 of a water-proof material such as plastic, and generally resembling a flashlight in shape. At one end of the device 10 an electric motor 26 that drives a central shaft 28 is mounted in a compression fit between two cylindrical walls 34 and 35 in a removable housing 36. The shaft 28 projects through an opening 31 in the front wall 34 and has a weight 40 eccentrically mounted thereon. When the windings (not shown) of the motors are energized, the shaft 28 rotates the eccentric weight 40 to produce vibrations.

In the middle portion of the device 10 means is provided to mount a power supply in the form of a pair of series connected batteries, such as “AA” batteries 42 and 43 mounted in a channel 68 between a contact button 44 on one cylindrical wall 66 and a metallic spring 45 mounted on another wall 67, as is known in the flashlight art.

An “on/off” switch 46, shown generally and schematically, is mounted on and through the casing 11 of the device 10 with the switching elements 71 and 72 of the switch 46 providing open and closed series electrical connection between the batteries 42 and 43 and the other elements connected in series thereto whereby the activation of the motor 26 and the vibrations it generates can be turned “on” and “off”.

A rheostat 50 to regulate the speed of the motor 26 is mounted on and through the casing 48 of a housing 51 at the opposite end of the device 10 from the motor 26. The rheostat 50, the on/off switch 46, and the windings of the motor 26 are connected in series electrical connection with the batteries 42 and 43 by a plurality of wires 54, the button 44 and the spring. The rheostat 50 is a conventional rheostat as known in the rheostat art and has a rotational knob 56 for varying the internal resistance (not shown) of the rheostat, and thus the current flowing therethrough, as is well known in the rheostat art. When the on/off switch 46 is “on”, the current from the batteries 42 and 43 passes through the wirings of the motor 26 to cause the motor shaft 28 and its eccentrically mounted weight 40 to rotate, causing vibrations to be generated and pass through the walls 34 and 35 and out to the outer face 37 of the housing 36. When the device 10 is secured on a fishing rod shaft 12, as described hereinafter, and the on/off switch is “on”, the fisherman can then manually turn the knob 56 of the rheostat 50 to adjust the current flowing through the windings of the electric motor 26 to vary the speed of rotation of the motor shaft 28 to modulate the frequency and amplitude of the vibrations transmitted to the outer face 37 of the housing 36 and then (FIG. 1) to the fishing rod shaft 12 and its line 18 and then to the lure 23.

Attachment means in accordance with one aspect of the invention allows the device to be easily attached to a fishing rod in a manner to prevent slippage of the device axially or rotationally of the shaft during the strenuous casting, and the hooking, playing and landing of a fish.

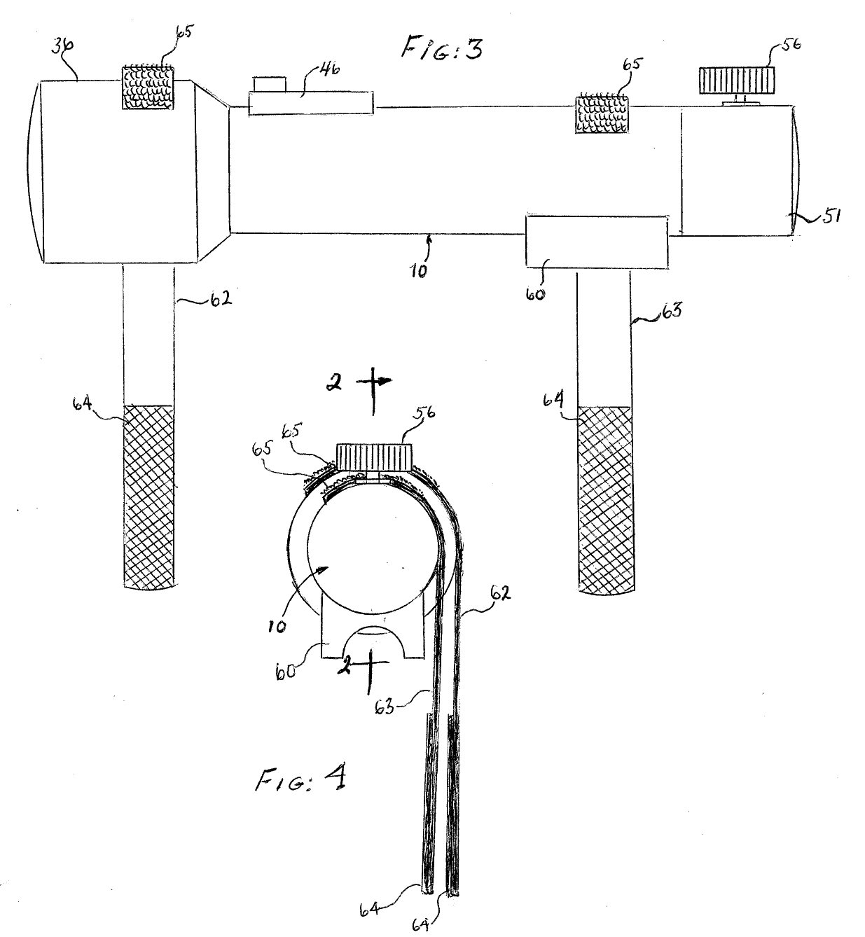

In the preferred embodiment, referring now to FIGS. 2, 4, 5 and 7, the fastening means comprises a relatively resilient friction means in the form of an elongated extension 60 attached to the bottom of the device 10 by an adhesive and projecting downwardly from the bottom of the device 10. The extension 60 is preferably of a length of at least two to two and one half inches, and has at its bottom an internal wall 61 defining a curvilinear in cross section cavity 74 which runs lengthwise of the device and opens downward from the device whereby the wall 61 of the cavity frictionally engages the top of the fishing rod shaft 12 to resist slippage of the device axially of, and rotationally on, the shaft 12 of an ordinary fishing rod in combination with at least two adjustable length strap-like wrapping means 62 and 63, each comprising at least one hook 65 and loop 64 fastening surface, such as Velcro® mating surfaces. One end 75 of each wrapping strap is secured to the device 10 such as by adhesive (not shown). One wrapping strap 62 is secured to the device 10 above the extension adjacent the vibration mechanism housing 36 and another wrapping strap 63 is secured to the device 10 adjacent the vibration control rheostat housing 51. By such arrangement the device 10 can be easily and securely attached to a fishing rod shaft, and remain attached despite the forces applied to it during the casting, hooking, playing and landing of the fish.

Attachment means in accordance with one aspect of the invention allows the device to be easily attached to a fishing rod in a manner to prevent slippage of the device axially or rotationally of the shaft during the strenuous casting, and the hooking, playing and landing of a fish.

In the preferred embodiment, referring now to FIGS. 2, 4, 5 and 7, the fastening means comprises a relatively resilient friction means in the form of an elongated extension 60 attached to the bottom of the device 10 by an adhesive and projecting downwardly from the bottom of the device 10. The extension 60 is preferably of a length of at least two to two and one half inches, and has at its bottom an internal wall 61 defining a curvilinear in cross section cavity 74 which runs lengthwise of the device and opens downward from the device whereby the wall 61 of the cavity frictionally engages the top of the fishing rod shaft 12 to resist slippage of the device axially of, and rotationally on, the shaft 12 of an ordinary fishing rod in combination with at least two adjustable length strap-like wrapping means 62 and 63, each comprising at least one hook 65 and loop 64 fastening surface, such as Velcro® mating surfaces. One end 75 of each wrapping strap is secured to the device 10 such as by adhesive (not shown). One wrapping strap 62 is secured to the device 10 above the extension adjacent the vibration mechanism housing 36 and another wrapping strap 63 is secured to the device 10 adjacent the vibration control rheostat housing 51. By such arrangement the device 10 can be easily and securely attached to a fishing rod shaft, and remain attached despite the forces applied to it during the casting, hooking, playing and landing of the fish.

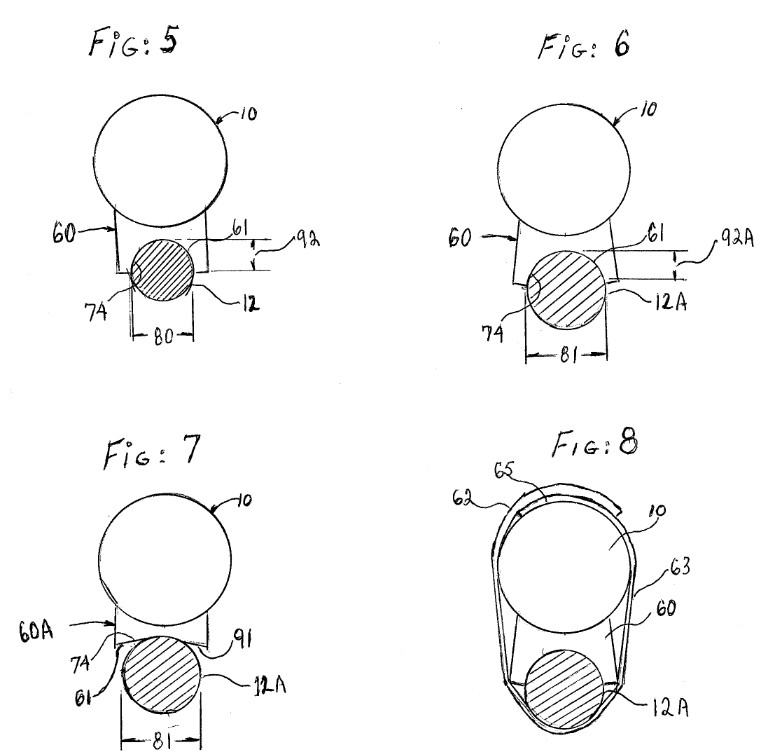

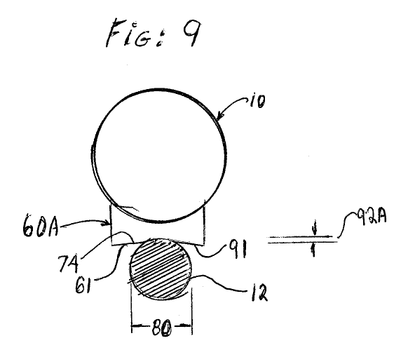

I have found that the device can be made to accommodate a range of fishing pole shaft diameters by varying the depth of the curvilinear-in-cross-section cavity 61 defined by the wall 74 and/or the durometer of the material. For example, FIG. 5 shows the wall 61 defining a cavity wherein the cavity defined by the wall 74 is deep, as at depth 92, and the fishing rod shaft is small. In such case, the wall 74 of extension 60 engages the fishing rod shaft as far down as the center line of the shaft. Unless the durometer of the extension is made soft as described later herein, such extension could not be pushed down on a larger diameter fishing rod. On the other hand FIG. 7 shows an extension having a more shallow depth 92A of the wall 74 defining the cavity 74. Such shallower depth accommodates a larger diameter shaft 12A than the deeper cavity 74 of FIG. 5 could accommodate. Yet, as FIG. 9 shows, the shallow cavity 92A can also accommodate the smaller diameter fishing rod shaft. It could also accommodate fishing rod shafts of diameters between the large diameters shown in FIG. 7 and the small diameter shown in FIG. 5. But in the combination of the present invention, involving the co-action with the above described wrapping means, the arrangements of FIGS. 5, 7, and 9 would all hold the device 10 securely on the rod during the rigors of casting the lure and hooking, playing and landing the fish.

Thus, the more shallow the cavity, the wider the range of fishing rod shafts it will fit. In a modification of the invention, I have found that where the durometer is soft, in the range between 30 and 45, the device can have a deep cavity, with its consequent frictional advantages, but will expand to fit more than one size of fishing rod. This is illustrated by a comparison of the assemblies of FIGS. 5 and 6. The use of a softer durometer extension 60 (FIG. 6) of the same dimension as the cavity 60 defined by the inner wall 61 of the extension 60 (FIG. 5) will allow the extension to expand to accommodate and compressively grip a much larger diameter fishing rod shaft 12A. Thus it can be seen that by varying the length of the projection, the flexibility of the material, and the depth of the cavity of the extension, the device can be manufactured to accommodate a single size of fishing rod shaft or a range of sizes

It is to be noted that the modification using the softer, lower durometer range, of material for the extension has the additional advantage of enabling a simple two-step assembly process wherein, by simply pushing the frictional extension 60 down against the top of the fishing rod shaft until a firm frictional engagement is established, the extension exerts sufficient friction to hold the device 10 firmly in place even before the straps are applied. This facilitates the attachment of the wrapping straps which provide the desired co-action with the extension to provide the ultimate securing of the device to withstand the forces of the casting, hooking, playing and landing of the fish.

In the preferred embodiment, the device 10 is of waterproof material and construction. The front and rear housings 36 and 51 can be removable for providing access to the vibrating mechanism and battery compartment and rheostat respectively. The caps can be removably attached by threading means as is well known in the flashlight art. The foregoing removable connections can be water-proofed by gaskets and the like as is also well known in the flashlight art.

Whereas, the present invention has been described with respect to specific embodiments thereof, it will be understood that various changes and modifications will be suggested to one skilled in the art and it is intended to encompass such changes and modifications as fall within the scope of the appended claims.

What is claimed is:

1. A device adapted for detachable attachment to an ordinary fishing rod, reel and fishing line assembly comprising:
attachment means mounted on the device adapted to detachably secure the device to the fishing rod against slipping axially and circumferentially of the rod with at least a portion of the device being in vibration transmittal contact with the shaft of the fishing rod;
vibration generating means having its own power source and mounted on the device to cause the devise to vibrate in a manner that transmits vibrations to the fishing rod shaft and then to the fishing line without the fishing line passing through the device.

2. A device as set forth in claim 1, including vibration control means to vary the degree of vibration produced by the device.

3. A device adapted for detachable attachment to an ordinary fishing rod, reel and fishing line assembly comprising:
an elongated body
vibration means mounted on the body and adapted to cause the devise to vibrate in a manner that transmits vibrations to the fishing rod and then to the fishing line;
attachment means mounted on the body for detachably securing the elongated body to the shaft of a fishing rod against slipping axially and circumferentially of the rod with at least a portion of the device being in vibration transmittal contact with the rod;
the attachment means including an extension depending from the bottom of the device and having at its bottom a cavity defined by a curvilinear wall adapted to engage the shaft of the fishing rod
strap means having one end attached to the device and another end free, and of a length to be able to be wrapped about the body and a fishing rod shaft, and having interacting fastening means on each end thereof to secure the ends in tight engagement once the strap has been wrapped about the fishing rod whereby the strap means co-acts with the extension to prevent movement of the device axially and rotationally of the shaft of the fishing rod

4. A device in accordance with claim 3 wherein the fastening means comprises a hook and loop means

5. A device in accordance with claim 3 wherein the strap means wraps around the device, the extension, and the fishing rod shaft

6. A device in accordance with claim 5 wherein the strap means includes at least two spaced straps, one of which wraps around the device, the extension, and the fishing rod shaft and the other is spaced therefrom towards the opposite end of the device from the extension.

7. A device in accordance with claim 3 wherein the extension is of a resilient material

8. A device in accordance with claim 7 wherein the resiliency is in a durometer range of 30 to 45.

9. A device in accordance with claim 3 wherein the range of fishing rod shaft diameters to which the device can be attached is established in manufacturing by an adjustment of the extension's length, durometer and depth of the cavity.
